(19) United States
(12) Patent Application Publication
(10) Pub. No.: US 2024/0053980 A1
(43) Pub. Date: Feb. 15, 2024

(54) SHORTENED NARRATIVE INSTRUCTION GENERATOR FOR SOFTWARE CODE CHANGE

(71) Applicant: INTERNATIONAL BUSINESS MACHINES CORPORATION, ARMONK, NY (US)

(72) Inventors: Marco Aurelio Stelmar Netto, Sao Paulo (BR); Lucas Correia Villa Real, Sao Paulo (BR); Bruno Silva, Sao Paulo (BR); Renan Francisco Santos Souza, Rio de Janeiro (BR)

(21) Appl. No.: 17/819,025

(22) Filed: Aug. 11, 2022

(51) Int. Cl. G06F 8/71; G06F 11/36

(52) U.S. Cl. CPC G06F 8/71; G06F 11/3688; G06F 11/3684

(57) ABSTRACT

A method, computer system, and a computer program product for generating instructions to highlight software change may be provided. In one embodiment, the technique comprises obtaining information about a requested modification to an original code of a software program and classifying it based on the type of change requested by the modification. The unit tests available are then identified. At least one of the identified unit tests are selected and customized based on classification of the type of code modification requested. Using the at least one selected and customized unit test, the differences between the original and modified code may be identified. One or more test execution stories are then generated related to the modification of the code, to highlight the changes. Test execution stories are further analyzed to provide any additional missing information.

### BACKGROUND

The present invention relates generally to the field of software design and more particularly to techniques for generating narrative instructions to highlight software code change.

Many reasons may exist that require computer code to be modified in an already existing software program or application. Software designs are ever changing, and new features may have to be added or removed from the existing application or program. Modifications may be needed to adapt to new environments and requirements, or patches and bug fixes may need to be installed to address issues. Modifying computer code in an already existing software program and application may be challenging.

Code modifications require an understanding of the existing application and prior historical changes of the code. Otherwise, improper modifications may detrimentally affect the application or the program. Understanding and tracking changes may be very important but it may also be very challenging. As the program or application goes through several different types of changes over time, the complexity of its design increases and modifications become more difficult. Furthermore, in recent years collaborative environments that include many contributors globally have increased these challenges. Even when code modification's impact can be anticipated, taking a substantial amount of time to complete them may adversely impact the runtime and application development.

### SUMMARY

Embodiments of the present invention disclose a method, computer system, and a computer program product for generating instructions to highlight software change. In one embodiment, the technique comprises obtaining information about a requested modification to an original code of a software program and classifying it based on the type of change requested. Any unit tests available are then identified and at least one of the available unit tests are selected and customized based on classification of the type of code change requested. Using the at least one selected and customized unit test, the differences between the original and modified code may be identified. One or more test execution stories are then generated related to the modification of the code as identified. The test execution stories highlight any changes between the original and modified code. Test execution stories are further analyzed to provide any additional missing information.

### BRIEF DESCRIPTION OF THE SEVERAL VIEWS OF THE DRAWINGS

These and other objects, features and advantages of the present invention will become apparent from the following detailed description of illustrative embodiments thereof, which may be to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 provides an operational flowchart for highlighting code changes according to one embodiment;

FIG. 3 provides an operational flowchart highlighting code changes according to an alternate embodiment;

FIG. 4 provides an example of a modification request cycle according to one embodiment; and

FIGS. 5a and 5b are complimentary processes showing a more detailed modification request cycle according to the embodiment of FIG. 4.

### DETAILED DESCRIPTION

Detailed embodiments of the claimed structures and methods may be disclosed herein; however, it can be understood that the disclosed embodiments may be merely illustrative of the claimed structures and methods that may be embodied in various forms. This invention may, however, be embodied in many different forms and should not be construed as limited to the exemplary embodiments set forth herein. Rather, these exemplary embodiments may be provided so that this disclosure will be thorough and complete and will fully convey the scope of this invention to those skilled in the art. In the description, details of well-known features and techniques may be omitted to avoid unnecessarily obscuring the presented embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

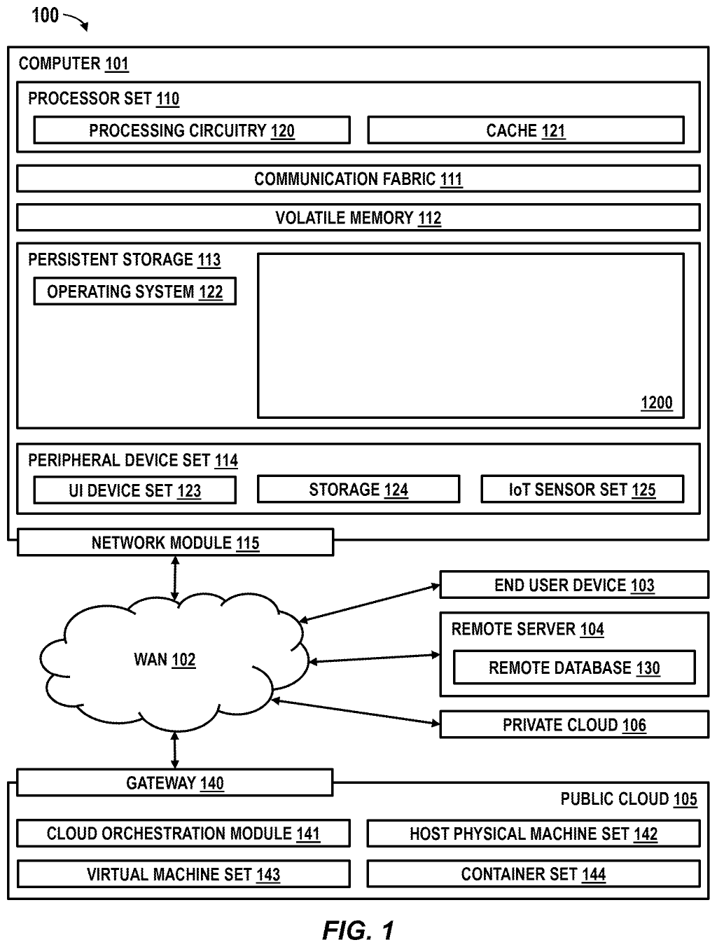

FIG. 1 provides a block diagram of a computing environment 100. The computing environment 100 contains an example of an environment for the execution of at least some of the computer code involved in performing the inventive methods, such as code change differentiator which is capable of generating narrative (1200). In addition to this block 1200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 1200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 of FIG. 1 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 1200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 1200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As discussed earlier, modification of software applications has been becoming increasingly complicated. Any modifications become even more intricate and challenging when the devices and the code involved resides in a distributed manner, in various locations and across different data centers. Some software modifications may include reviewing traces or logs, such as after test execution and performing test analysis of errors. However, most of these processes requires extensive and time-consuming code examinations. Sometimes these examinations are textual and easier to understand but at other times they may non-intuitive and directionless. In addition, other aspects of the software including code quality, code complexity, and code cohesion, may involve manual tasks, such as executing and understanding multiple different testing tools. These processes are costly both in terms of time and money.

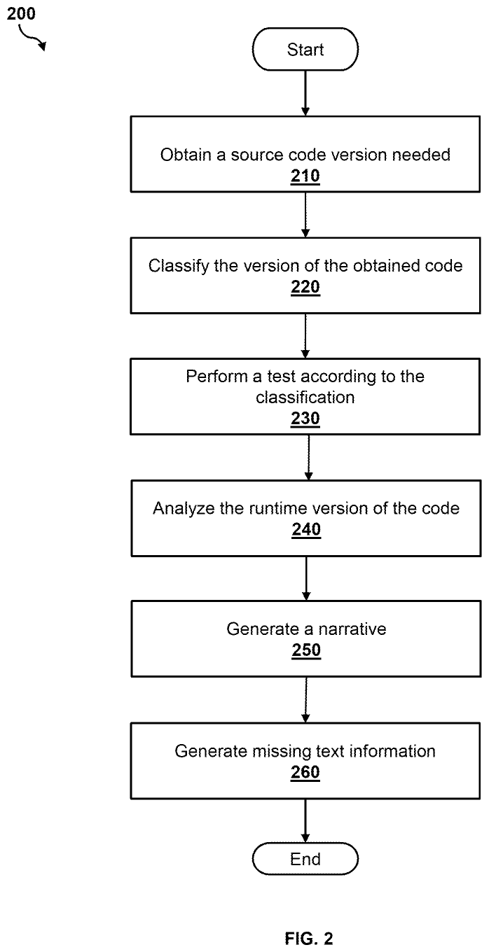

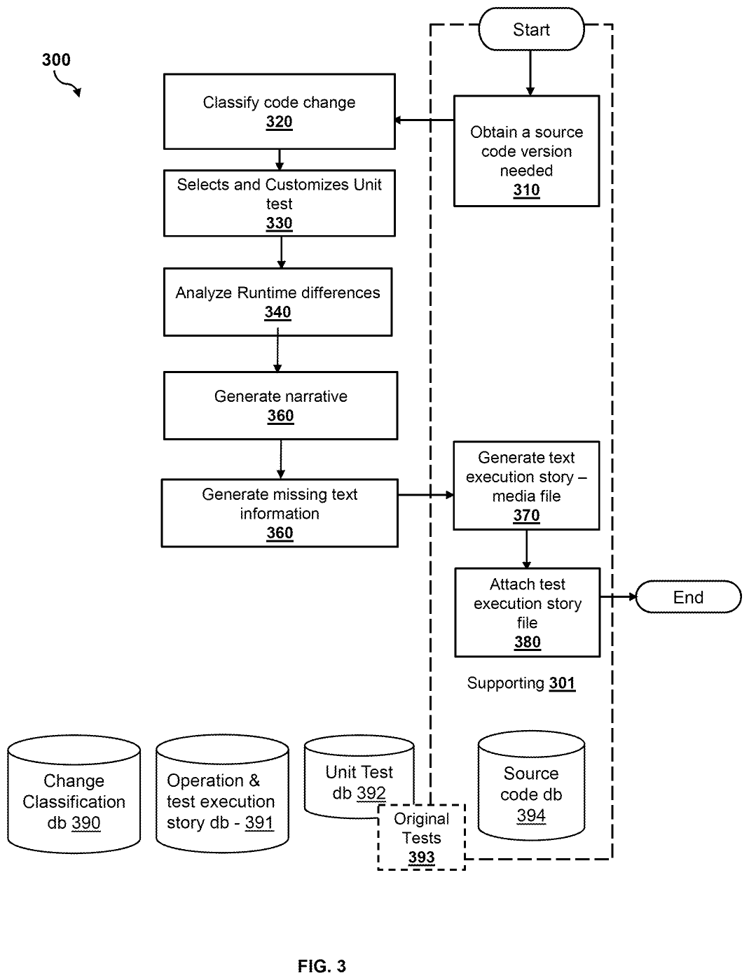

In FIGS. 2 and 3, as per one embodiment, a technique may be provided that will mitigate the complexity of code and test reviews such as by providing a visual analysis. This technique may provide live feedback to a user/programmer through an analysis and in real execution-time (using several software metrics) to address problems and acquire additional valuable information. For example, the process of blocks 200 and 300 (FIGS. 2 and 3) when used in different embodiments including an extended reality environment, through a selected set of metrics, can allow a user/programmer/developer to check the evolution of the code. This allows the developers to test or program sections effectively and by reducing the development time.

In some examples, given a scenario in which developers and programmers are the project maintainers of a program, requesting a modification will lead to revisions of a complex code base. These modifications require a careful design and an understanding of all potential side-effects of the proposed code change. Usually, the maintainers of the program and the developer/programmers have to cooperatively resort to pencil and paper, in order to keep track of data structures modified by such a code change. They may need to even create a mental map of the code structure so they can picture how the code changes relate to that structure. As discussed earlier, these efforts are time consuming, may be costly and may even be prone to interpretation errors. The techniques as provided by process 200, greatly improves the process without the usual side effects associated with code changes (including addition of bugs.)

FIGS. 2-3 provides a flowchart illustration of different embodiments. In one embodiment, as captured by FIG. 2, a shortened narrative instruction is generated to highlight runtime impacts of software code change based on automatic transformation of test cases that may include relevant data structures, data flow, message exchanges and the like. The instructions can be used to generate videos, figures, three-dimensional (3D) objects or text to highlight the side effects on execution of software due to new source code changes. This also allows software developers to better understand how new source code impacts the execution of the existing software.

The techniques provided can be used with both two dimensional and 3D content. For example, in recent years, it has been established that code and data can be visualized in three-dimensions (3D) and better understood by means of animation and anthropomorphizing. A metaphor has been established for the human viewer to understand the visualization of abstract mathematical constructs that operate on scales beyond normal cognitive range. Some scenarios have used man-made structures such as in the real world to envision software as if in a city inhabited by many dynamic entities whose behavior could be understood by means of direct observation. Some source code editors provide visual based editing to help with debugging, syntax highlighting, code completion and the like. Some necessary functions can include theme, keyboard shortcuts, preferences, install extensions an add functionality. The present methodology as used in FIGS. 2-5 can also be used with these new and emerging extended realities. However, the process discussed in FIGS. 2-4 may not be limited to the extended realities or any (particular) source code editors and can be used in conjunction with any other scenarios.

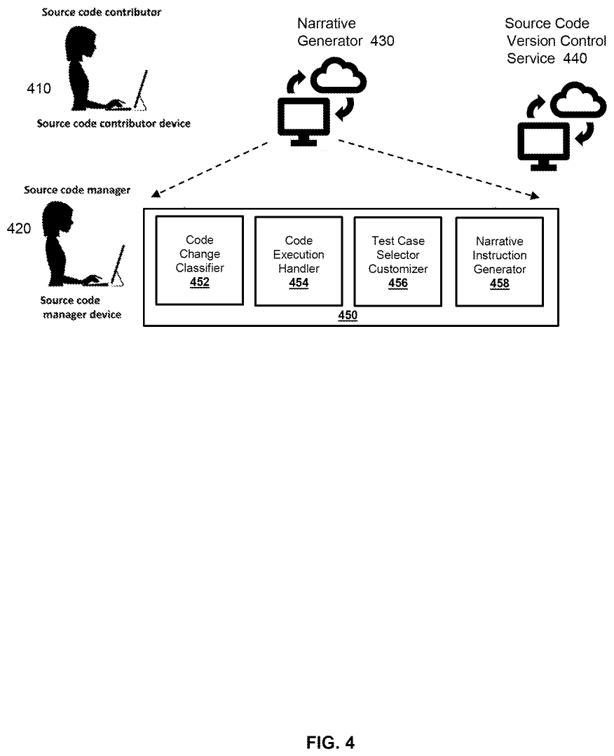

The processes 200/300 as shown in FIGS. 2-4 provides, according to one embodiment, an automatic technique for the generation of shortened narrative instructions that emphasize how new code changes affect runtime execution of the existing software (relevant data structures, data flow, and message exchanges) based on:
(i) Natural language processing (NLP) on the messages (i.e., commit messages), code comments, and Abstract Syntax Tree (AST)+ontology-based code analysis to extract code change classes (see FIG. 4 410/458);
(ii) Usage of code change classes to select and configure existing software test cases that can highlight new software execution flows (see FIG. 4—452 and 454);
(iii) automatic generation of narrative texts in the absence of comments and commit messages based on code change class detection (See FIG. 4—410/456 and 458).

FIG. 2 provides a flowchart depiction of a process 200 that can generate a shortened narrative instructions to highlight runtime impacts of software code change based on automatic transformation of test cases. This may be particularly useful in immersive environments that employ extended realities. The process 200 generates a set of narrative instructions that could be used in conjunction with a variety of media and for other purposes. These narratives can in turn be used to generate videos, figures, 3D objects or text to highlight the side effects on execution of software due to new source code changes. This may be particularly useful in immersive environments that employ extended realities.

In the embodiment of FIG. 2, a flowchart depiction of a first embodiment may be provided for generating a software change runtime. The process of providing this automatic technique with an impact narrative may be illustrated at 200. In one embodiment as illustrated, the process starts at Step 210.

In step 210, it may be determined that a code of a software program may be changed or may be scheduled to be changed. The code can be a source code in an embodiment. The original version of the (source) code can be obtained or received from a variety of sources, such as a database. The modification to the code might have already happened or it may be scheduled to happen in the future.

In Step 220, the type of modification may be determined. The type of modification will be used to classify the change. In some embodiment, there may be more than one change and more than one classification. In one embodiment, classifying the modified/revised/updated version of the source code can include selecting from a list of activities. For example, one can pick whether the new code may be a bug or problem fix or a new feature to be added. In some embodiments, the change to the code may be detected automatically by the system (processor). In other embodiments, the code can be selected by the user or a code manager using a more obvious method such as a drop-down menu, a 3D tool or the like. In the latter case, it would be easier to detect the change.

The code change request for modification, when not obvious, may be detected using a variety of strategies. In one strategy, activities may be monitored, and change will be detected using natural language processing (NLP). For example, commit messages associated with the modified/revised version can be detected and processed. Another strategy may be to use abstract syntax tree (AST) and associated ontology to search for various revised versions and changes to the code. In one embodiment, a variety of different methods may be combined. The strategies provided are to ease understanding and these and/or other strategies can be used or combined in alternate embodiments.

In Step 230, different unit tests are analyzed. A unit testing may be usually defined as a type of software testing where individual components of the software are tested. Many unit tests are done automatically to isolate sections of the code and verify its correctness and monitor proper functioning of the code section and procedure. Unit tests are established to allow the developers to learn functionality may be adequately provided and integrity may be ensured. Therefore, understanding the code change through classification (previous step), allows the review of original unit tests that were set up and available to understand the code change. For example, a modified unit test that may be performed according to a classification of the revised version of the source code indicates code change blocks to be later highlighted.

In Step 240, the modified/updated code may be compared and analyzed against the original code. In one embodiment, a runtime execution of the original source code may be analyzed, against the modified version (revised) of the source code. In one embodiment, analyzing the run time execution of the original source code and the revised version identifies executional divergence between them.

In Step 250, a narrative may be generated associated with the analysis of the run time execution of each of the original source code and the revised version of the source code. The narrative may also be augmented selectively. In one embodiment, the narrative can be generated by highlighting differences in run time execution of the unit test by each of the original source code and revised version. In one embodiment, a narrative file may be generated that may be associated with the revised version of the original source code in a code storage system. In one embodiment, the narrative file highlights the steps performed by the revised version of the source code.

In Step 260, the narrative may be reviewed and any missing information that requires to be added may be provided for a final summary. This will be discussed in more detail in conjunction with the embodiment of FIG. 3.

FIG. 3 provides an alternate embodiment of FIG. 2. Some of the steps in FIG. 2 and FIG. 3 are very similar. However, the embodiment of FIG. 3 provides additional details and some differences. FIG. 4 provides a scenario that can be used in conjunction with the processes of FIG. 2 or 3.

FIGS. 3 and 4 can be discussed together to provide a better understanding. The scenario of FIG. 4 as illustrated by the block diagram, provide a source code contributor 410 and a source code manager 420 that can request code change and interact with the system/processor. For example, the source code contributor 410 can provide a pull request that includes instructions for code modification. The source code contributor may not always be the source of the pull request and in other embodiments, the request may be received/obtained from other sources.

In many conventional scenarios, once the request has been received, no matter the source, the maintainers of the code (may even be source code contributor 410 or manager 420) may need to go through the effort of carefully understanding potential side-effects of the proposed code change. As discussed earlier, this effort may be so substantial that pencil and paper has to be often utilized to keep track of data structures modified by such a code change. Such efforts may be costly, time consuming and prone to interpretation errors. The process as provided by FIGS. 2-4 (such as captured in box 450, by narrative generator module 430 and source code version control service 440) addresses this problem. The solution partially shown illustratively by box 450, eliminates the time and effort for reviewing and accepting source code change from contributors and possible negative side-effects of these code changes, including addition of bugs. Source code version control service 440 can be used for obtaining source code as appropriate.

The process 300 in FIG. 3 provides what may be provided in box 450 of FIG. 4. The process 300 starts with a request or a task to be provided. For example, referring back to the example discussed in FIG. 4, a pull request may initiate the process. However, in alternate embodiments, as can be appreciated by those skilled in the art, other processes that will attribute to a code change (patch file etc.) can start the process. In one embodiment, there may also be one or more input (sets of unit tests and their input data, for example). The system which can simply be comprised of a processor or a multi device network having many processors will perform the process 300. For ease of understanding, the process ca be discussed below in conjunction with the scenario provided in FIG. 4.

In Step 310, the code change request may be received or alternatively obtained. In one example, as was discussed in FIG. 4, a source code contributor (410) may submit a pull request or a patch file to a source code version control service (FIG. 4 at 440). The processor then analyzes monitors such events to detect anything that needs handling associated with the event in order to generate a narrative or alternatively a text execution story. In one embodiment, for example, a pull request test case can be used to examine the runtime variable values and the code execution flow according to the code changes. For instance, if a given parameter changes from a scalar to a vector, our solution can execute the code to inspect the newly created vector. For pull requests with only the source code and no tests, the system can check if any existing test (previous) uses the new code and proceed accordingly.

In Step 320, the type of modification (code changes) are classified. There may be several types of code changes, including but not limited to
(i) an addition of a new feature,
(ii) an optimization in the software execution speed,
(iii) support for a new type of input file, and
(iv) bug fixes such as removal of memory leaks. In this step the proposed system can have different strategies to classify such changes.

Some of the strategies that may be employed will now be discussed. However, it should be understood that these strategies are only being discussed for ease of understanding and in alternate embodiments, other or a combination of these and other strategies may be employed.

A—Natural Language Processing (NLP) of the commit messages. In this instance, the source code contributor may have included a message about the code change which could be parsed to find verbs, nouns, and actions such as: “memory leak”, “improved memory consumption”, “added support for . . . ”, “optimized . . . ”, etc.

B—NLP on code comments introduced (or modified) by the code change may be used in the same manner (same processing steps) as discussed before.

C—Abstract Syntax Tree (AST) and ontology searches. This strategy includes data types, functions, and classes of elements touched by the source code change. These may be identified based on:
(i) support for reflection in programming language,
(ii) on the context in which they are used in the source code, and
(iii) on the metadata available in ontologies regarding such elements. An example of classification using such strategy may be, for instance, a code change that replaces a machine learning algorithm “A” with another algorithm “B”—in which case the strategy could be classified as “algorithm replacement”.

D—Identification of similar labeled code. Assume the pull request code may be similar to a previously analyzed code, in this case, the system can assign the new label according to a predefined similarity metric. The metric can use the code AST similarity or even the programmer comments+NLP to calculate this index.

E—as an alternative embodiment, a drop-down list can be provided, in which the programmer labels the new contribution using a set of predefined values (i) new feature, (ii) bug fix, (iii) performance enhancements.

In Step 330, the system selects and customizes unit tests. In this step, the processor/system, may identify existing unit tests that are affected by the code change (using, e.g., AST processing or simply comparing the execution trace of the unit test before and after the introduction of the code change). The subset of unit tests that relate to the code change are then modified so that their input (and output) are reduced to the bare minimum number of elements needed to demonstrate the code change in effect. For example, if a unit test had an array of input elements [1100, 1101, 11070.3, 2100], then this step would execute the unit test up to 4 times (one for each element in the input array). Once an array with the minimum number of elements has been produced the system proceeds to the next step. Another example may be when a code change may be related to a problem fix due to memory leak. A test case based on an array could have the array increased by a factor (example 10 times) in order to more quickly demonstrate that the memory leak was fixed.

In addition, in one embodiment, most of the existing test cases generations may try to maximize the coverage of source code. Generally, the tests employ large datasets to exercise several parts of code (e.g., stress tests). This possibility may be further used to generate test cases that minimize test data in order to simplify the understanding of code changes.

In Step 340, the run time differences between the original code and the changed code may be analyzed. Using tracing and monitoring techniques (such as “strace” and “valgrind”), the system collects logs as the original code executes with the reduced unit test produced by step 330. Afterwards, it repeats the process with the new code changes applied to the code base. The system then proceeds to verify the point in execution time in which the two executions start to diverge (i.e., the point in which the new code modifies the behavior of the original one: changes to the range of values attributed to a given variable, a different path taken in the execution graph, disappearance or introduction of certain variables, etc.). The execution stack trace at that point may be captured and recorded for use by the next step. The user may also set up different system change explanation according to user's preferences. For instance, the user may want to explain each changed code part or set a threshold based on runtime/static change to identify parts of the code that must be highlighted.

In Step 350, one or more test execution stories (alternatively narrative instructions) may be generated. In one embodiment, this may include associating blocks of operations that are performed by the software execution to the “subtitles” or “labels” produced as output of step 320. This operation applies to the execution of both the original and new code versions. As the software executes and the program counter advances, our system detects where the code has changed and creates the associations with the “labels”.

In Step 360, the missing text and information may also be generated. In one embodiment, there may be a plurality of databases (db) that can be accessed by the processor to obtain and store additional information for later use. Some of these databases are shown at 390-394. The databases that are used here by way of example include Code changes classification db 390, operations and test execution story (narratives) db 391, Unit test db 392/393 and Source code db 394. These can be used as supporting databases selectively depending on the selected embodiment. (In one embodiment Unit test db 392/393 comprises both unit tests and the strategies for unit test adaptation).

Referring back to Step 360, the generation of the missing text may be made easier through the access to one or more of the databases shown. For example, the software operations and narratives database 391 may be used with the major operations performed by the software execution that could not be mapped by the previous step 350 (when translated into narrative actions.) For instance, a method call such as “vector.push_back(‘foo’)” may be translated into the sentence “System pushes an element into the vector”. Similarly, a sequence of such operations may be grouped and translated into “System pushes elements into the vector”. A narrative may also include auxiliary graphical instructions such as “Move box ‘foo’ towards the right-hand side of rectangle ‘vector’”. The system can use similar labeled code parts to identify use their labels in the current code change. For instance, assume a new commit without any code comment or commit message. In this case, the system can identify similar code in the operations and test execution story (narrative) db 391 and label the new code.

In step 370, test execution story media files are generated. A media file such as a high-level document may be assembled by the system to summarize steps performed by the software up to the point of divergence in their execution, and to highlight (by the use of different colors, for example) the point where their execution changed. The system may also generate an animated document (such as a rich Video file with transition actions) that allow a graphical depiction of classes, objects, and operations that are touched by the unit test and affected by the new code change. The system may create as many narrative media files as candidate unit tests chosen by step 330.

In Step 380, test execution story media file in source code may be attached. In one embodiment, the user may be given the option to choose which media files to attach to the source code change versioning (such as a GitHub's Pull Request) as supplemental material. The reviewer of the pull request may be then presented with that narrative media file next to the actual code change. Other changes to the user interface may include a playback button so that the reviewer can watch a video preview of the changes prior to analyzing the actual code changes.

In addition, as indicated in FIG. 3 by 301, Steps 310 and 370-380, are more provided as a supporting function and can be added or subtracted from the process alternatively. In addition, the databases Change classification (390), and operation and test execution story (narratives) database (391) may be more needed in the regular operation while the source code database (394) may be used more on an as needed basis. The Unit test database (393) may be also more critical, but it may have some elements (original test cases 392) that are more selectively needed.

In alternate embodiments, some other steps and elements may be added to the process selectively. For example, the commit type guides may be provided and selected as per a template. In addition, the type of execution and possible templates may be characterized based on commit messages. In one embodiment, when a user produces a modification that actually happens to have an impact in the Graphical User Interface (GUI) or there may be another visual change, a different template may be presented for that particular case based on a selective rendering. In another embodiment, templates of animations may be incorporated to facilitate assembling media files (Step 370).

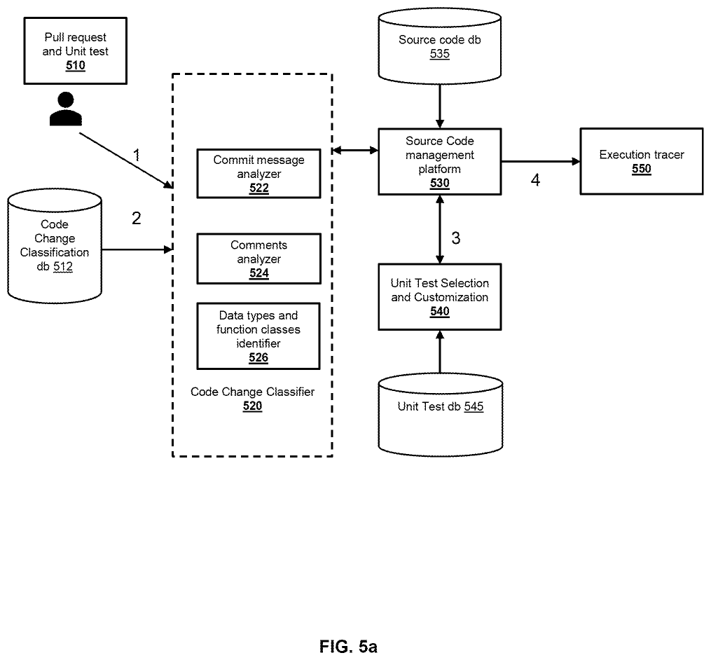

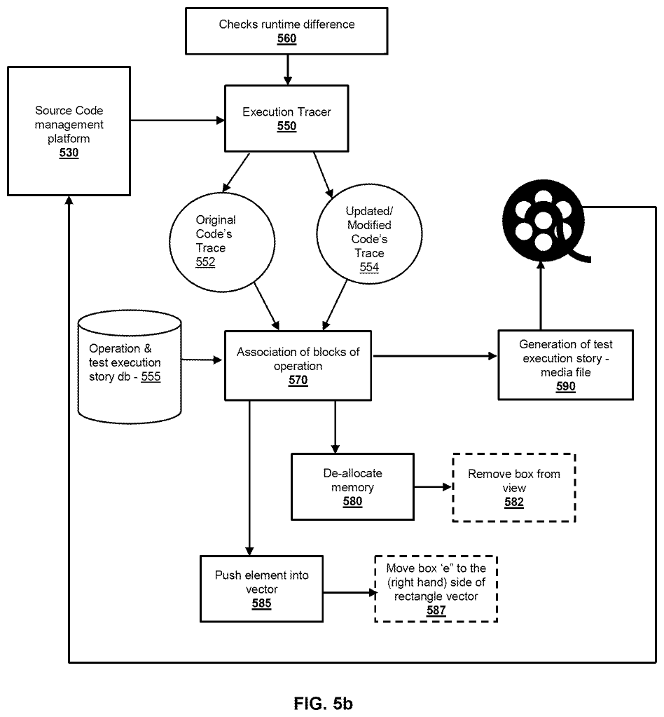

FIGS. 5a and 5b provide complementary processes that provide additional details to the process discussed in conjunction with FIGS. 3 and 4.

In FIG. 5a, a particular scenario may be provided that commences with the receipt of a pull request at 510 (arrow 1). The Code change classifier 520 analyzes the pull request and obtains other data such as the different versions of the code from the Code Change Classification database 512. In this scenario, the code change classifier 520 has components that analyze the commit message 522 and the comments 524 and other types and functions 526 to classify the change requested.

Once the code change has been classified, the classification may be provided to the source code management platform 530 that can both receive input from the code change classifier 520 and provide input and information to it to help the classification and reclassification. This information can be stored and reused when new or similar code changes are requested to help with efficiency and speed of classification.

It should be noted that the source code management platform receives information from the source code database 535. It may be also in communication with the Unit test selection and customization module 540 so that the tests can be selected and customized accordingly as discussed earlier. The Unit test selection module 540 can obtain information form the Unit test database 545. The result may be provided to the Execution tracer 550.

The interaction of Source Code management platform 530 and Execution tracer 550 may be also shown at FIG. 5b. The input provided by the source code management platform 530 that may be provided to the Execution tracer 550. The original code 552 and the modified code 554 are obtained and also input form the runtime difference checking module 560. The result may be provided by association of blocks of operation that need to be highlighted due to code change as shown at 570. Input from the operation and text execution db at 555 may be also provided. In one embodiment this may be accomplished by labels, graphs or other means that provide such highlighting. Thereafter a test execution story may be provided through a media file at 590.

With the advent of technology, immersive application platforms can be used to create an extended reality rendered view of a live graphical model of a codebase for display to make the code testing less complex. This may be especially useful when an extended reality device or environment may be used. In one embodiment, a particular immersive application platform may generate the live graphical model based on test data generated by the test, may modify the live graphical model and/or the extended reality rendered view of the live graphical model as the test may be executed on the codebase. This allows the immersive application platform to enable the user/programmers comprehend the structure of the software and how it may be exercised by the test via a more intuitive medium. The visualization may also allow the user/programmer to locate hotspots of the codebase and understand the execution times of the one or more elements, inoperable code included in the codebase, unreachable code included in the codebase, infinite loops in the codebase, and redundant code included in the codebase. Therefore, the media file can include any type of video or extended reality type files that enable this as well.

The media files may be also provided in turn to source code management platform for use and storage and historical use. The information that may be no longer needed can be de-allocated from memory at 580 and removed from view at 582. Similarly, a push element vector may be provided at 485 that can move box “e” to the side of the rectangle vector at 587.

The descriptions of the various embodiments of the present invention have been presented for purposes of illustration but may be not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for generating instructions to highlight software changes, comprising:
obtaining information about a requested modification to an original code of a software program;
classifying said modification requested based on a type of change;
identifying a plurality of unit tests available and selecting and customizing at least one of said unit tests based on classification of said type of code change requested;
using said at least one selected and customized unit test to determine differences between said original code and said modified changed code;
generating one or more test execution stories to highlight any changes between said original code and said modified code; and
analyzing said test execution stories and reviewing previous code changes stored in a database to provide additional missing information from said test execution stories.

2. The method of claim 1, wherein the information about code modification is obtained by monitoring events associated with said software program including variable value changes.

3. The method of claim 1, wherein said code change has not been made but is scheduled to be made and said information about said code modification to be made is obtained by monitoring events associated with said software program including variable value changes.

4. The method of claim 1, wherein a code change type includes one of a group including: addition of a new feature, support for a new type of input file, an optimization feature to improve speed of execution, or a patch to provide a code fix to a problem.

5. The method of claim 4, wherein detecting and classifying said type of change is performed through detecting NLP of commit messages generated.

6. The method of claim 4, wherein detecting and classifying said type of change is performed through detecting AST and ontology search.

7. The method of claim 4, wherein detecting and classifying said type of change is performed by identifying similarly labelled code.

8. The method of claim 1, wherein said unit test selection and customization is performed by identifying existing unit tests affected by said modification.

9. The method of claim 8, further comprising modifying a subset of unit tests that relate to said code change so that their input is reduced to a minimum number of elements needed to demonstrate said code change.

10. The method of claim 1, wherein analysis of differences between original and modified changed code is done through using tracing and monitoring, including log collection.

11. The method of claim 1, wherein a test execution story instruction is generated by associating subtitles and labels to at least one block of modified changed code portion.

12. The method of claim 1, further comprising generating a test execution story media file, wherein said test execution story media provides content to summarize steps up to point where said original and said modified code diverge.

13. The method of claim 12, further comprising attaching said test execution story media file to a code modification change versioning as supplemental material.

14. A computer system for data processing, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
obtaining information about a requested modification to an original code of a software program;
classifying said modification requested based on a type of change;
identifying a plurality of unit tests available and selecting and customizing at least one of said unit tests based on classification of said type of code change requested;
using said at least one selected and customized unit test to determine differences between said original code and said modified changed code;
generating one or more test execution stories to highlight any changes between said original code and said modified code; and
analyzing said test execution stories and reviewing previous code changes stored in a database to provide additional missing information from said test execution stories.

15. The computer system of claim 14, wherein the information about code modification is obtained by monitoring events associated with said software program including variable value changes.

16. The computer system of claim 14, wherein said code modification has not been made but is scheduled to be made and said information about said code modification to be made is obtained by monitoring events associated with said software program including variable value changes.

17. The computer system of claim 14, further comprising:
generating a test execution story media file, wherein said test execution story media provides content to summarize steps up to point where said original and said modified code diverge; and
attaching said test execution story media file to a code modification change versioning as supplemental material.

18. A computer program product for data processing, comprising:
one or more computer-readable storage medium and program instructions stored on at least one of the one or more tangible storage medium, the program instructions executable by a processor, the program instructions comprising:
obtaining information about a requested modification to an original code of a software program;
classifying said modification requested based on a type of change;
identifying a plurality of unit tests available and selecting and customizing at least one of said unit tests based on classification of said type of code change requested;
using said at least one selected and customized unit test to determine differences between said original code and said modified changed code;
generating one or more test execution stories to highlight any changes between said original code and said modified code; and
analyzing said test execution stories and reviewing previous code changes stored in a database to provide additional missing information from said test execution stories.

19. The computer program product of claim 18, wherein the information about code modification is obtained by monitoring events associated with said software program including variable value changes.

20. The computer program of claim 18, further comprising:
generating a test execution story media file, wherein said test execution story media provides content to summarize steps up to point where said original and said modified code diverge; and
attaching said test execution story media file to a code modification change versioning as supplemental material.
